(19) United States
(12) Patent Application Publication
(10) Pub. No.: US 2015/0163140 A1
(43) Pub. Date: Jun. 11, 2015

(54) METHOD AND SYSTEM FOR DYNAMIC USAGE OF MULTIPLE TABLES FOR INTERNET PROTOCOL HOSTS

(71) Applicants: Edward J. Rovner, Chapel Hill, NC (US); Donald B. Grosser, Apex, NC (US)

(72) Inventors: Edward J. Rovner, Chapel Hill, NC (US); Donald B. Grosser, Apex, NC (US)

(21) Appl. No.: 14/565,343

(22) Filed: Dec. 9, 2014

Related U.S. Application Data
(60) Provisional application No. 61/913,837, filed on Dec. 9, 2013.

(51) Int. Cl. H04L 12/741

(52) U.S. Cl. CPC H04L 45/745

(57) ABSTRACT

A network switch has a plurality of data tables accessible to a plurality of networking protocols. Each of the plurality of data tables contains a plurality of entries. One of the plurality of data tables is selected in which to reserve a respective one of the plurality of entries as an entry for use by one of the plurality of networking protocols. The utilization of each of the plurality of data tables is compared responsive to an operation of the one of the plurality of networking protocols that causes a need to reserve the entry, and one of the plurality of data tables is selected in which to reserve the entry, based on the comparison.

### RELATED APPLICATION

This application claims the benefit of U.S. Provisional Application No. 61/913,837, filed Dec. 9, 2013, the entire disclosure of which incorporated herein by reference.

### FIELD

Embodiments of the invention relate to computer networking, and more particularly to dynamically selecting one or more look up tables in which to create an entry based on current utilization of the one or more tables at the time of entry creation.

### BACKGROUND

With reference to FIG. 1, networking equipment hardware 100 that forwards unicast Internet Protocol (IP) packets typically use specialized ASIC chips 101 that contain lookup-tables 105, 110, 115. These lookup-tables can be shared among resources of various types. For example, switching ASICs from Broadcom Corporation contain the following two types of lookup-tables used for forwarding IP unicast packets:

“Layer 3” (L3) table 105. This Layer 3 table can be shared by IP version 4 and IP version 6 hosts for unicast, as well as IPv4 and IPv6 multicast (IPMC) entries.

“Longest Prefix Match” (LPM) table 110. This LPM table can be shared by IPv4 and IPv6 routes with prefix mask lengths between 0-32 bits for IPv4, or 0-128 bits for IPv6, as well as IPv4 and IPv6 hosts for unicast, using a complete mask length of 32, and 128-bits, respectively.

Separately, there can be a “Next Hop” table 115 referenced by these, and other types of, lookup-tables. This Next Hop table contains information for forwarding packets, such as egress port number and destination MAC address. This Next Hop table can be referenced by the Layer 3 table 105, LPM table 110, as well as lookup-tables for other network resource types such as MPLS 120, Tunnels 125, and TRILL 130. These tables are illustrated in the prior art diagram in FIG. 1.

The sharing of these tables by multiple resource types presents a problem on which method to program IPv4 and IPv6 hosts. IPv4 and IPv6 hosts can be added using one of three methods described as follows, with their pros and cons:

Method (A)

In L3 table as a “Normal View” entry.

See IP Hosts A1 and A2 at 135 in FIG. 1.

Pro: uses just one entry in the L3 table for each host.

Con: uses a Next Hop entry in Next Hop table 115.

Resource contention with MPLS+Tunnel+TRILL, and with IPMC.

Method (B)

In L3 table as an “Extended View” entry, containing full next hop information.

See IP Hosts B1 and B2 at 137 in diagram in FIG. 1.

Pro: does not use a Next Hop entry.

Con: uses two entries in the L3 table.

Resource contention with IPMC entries at 139 in L3 table, and twice the L3 table usage per host compared to method (A).

Method (C)

In LPM table 110 as a 32-bit mask length route for IPv4, or 128-bit route for IPv6.

See IP Hosts C1 and C2 at 140 in diagram in FIG. 1.

Pro: uses no space in L3 table.

Con: uses a Next Hop entry and an LPM entry.

Resource contention with IP routes in LPM table at 142.

It is not obvious, to one skilled in the art, the best way to handle the possible table space contention among the various resource types. Some sub-optimal approaches not used in embodiments of this invention include:

Configure the networking equipment “a priori” with the various amounts required for IPMC, MPLS, Tunnel, TRILL resources. This is burdensome on the user, and is far from “plug-and-play”. If the user misconfigures the amounts required, hardware table space can be under-utilized, and can result in slower processing of network traffic in software.

Programmatically pick a preferred method order, such as method (A) then method (B) then method (C). For example, adding all IP hosts using method (A), then changing to method (B) then (C), only when various table resources become “full”. Always using one method order is the same as assuming that all customers' networks require a large number of IPMC, or alternatively, a large number of Next Hops for MPLS, Tunnel or TRILL. Such assumptions about demand for resources will not suit all customers.

### SUMMARY OF THE INVENTION

A network switch has data tables accessible to various networking protocols. Each of the data tables contains a number of entries. One of the data tables is selected in which to reserve a respective one of the entries as an entry for use by one of the networking protocols. In particular, the utilization of each of the data tables is compared in response to an operation performed by one of the networking protocols that causes a need to reserve the entry, and one of the data tables is selected in which to reserve the entry, based on the comparison.

### BRIEF DESCRIPTION OF THE DRAWINGS

FIG. 1 illustrates various data tables used in connection with an embodiment of the invention.

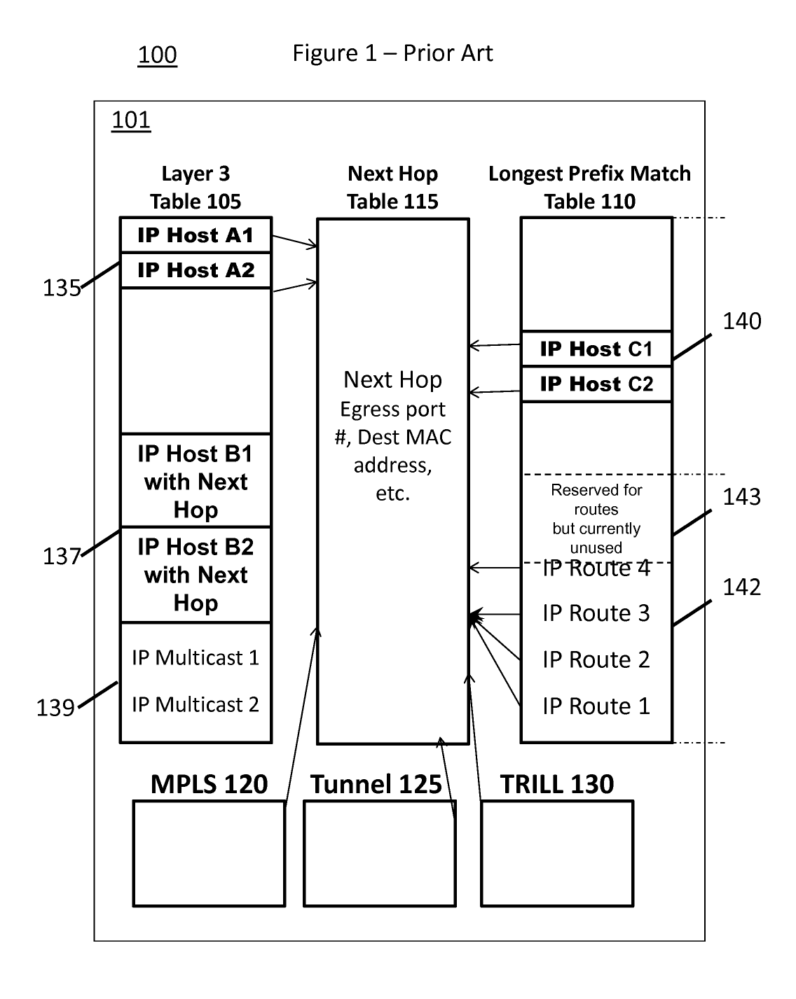

FIG. 2 is a flow chart of an embodiment of the invention.

FIG. 3 is a flow chart of an embodiment of the invention.

### DETAILED DESCRIPTION

The choice of which of the three methods (A), (B) or (C) described above to add an IP host to an appropriate data table is based on the current utilization of the Next Hop table 115 and the L3 table 105 at the time an IP host is to be added. New hosts are dynamically steered towards the less-utilized resource. Embodiments of the invention automatically adapt to accommodate the needs of other resource types.

Before describing embodiments of the invention, note that prior art (e.g., U.S. Pat. No. 8,059,658 issued to the assignee of the present application) already provides the option to provision or reserve a desired amount of space for IP routes in the LPM table. The prior art allows IP hosts to occupy space in the LPM table that is either unreserved for IP routes, e.g., at 140, or reserved-but-currently-unused by IP routes, e.g., at 143.

According to the embodiments of the invention, let “%NH” be the current percent utilization of the Next Hop table 115, and let “%L3” be the current percent utilization of the L3 table 105. Note that the L3 table is organized in one embodiment as a hash table, so available space somewhere in the L3 hash table does not guarantee a specific IP host will hash to an available spot. To more accurately assess how full is the L3 hash table, the percent utilization of the L3 table is normalized in one embodiment from 0% up to a maximum of, say, 75% of available space. In other words, L3 hash table utilization is considered 100% full when, say, only 25% empty space remains in the L3 hash table.

Embodiments of the invention contemplate the following four cases and corresponding actions:

Case (1): %L3 is Less or Equal to %NH.

Try to conserve Next Hop table space by using method (B) to add the new IP host as an “Extended View” entry to the L3 table, which does not use a Next Hop. There is relatively more room in the L3 table than the Next Hop table, so method (B) is preferred over method (A) or (C) which do use a Next Hop.

Case (2): %L3 is Greater Than %NH, and the LPM Table has Room in the Unreserved Route Space.

Try to conserve L3 table space by using method (C) to add the new IP host to the LPM table. There is relatively more room in the Next Hop table than the L3 table, and the LPM table has space for hosts, so method (C) is preferred over method (A) or (B).

Case (3): %L3 is Greater Than %NH, and the LPM Table Only has Room in the Reserved-but-Unused Route Space.

Try to conserve LPM and L3 table space by using method (A) to add the new IP host as a “Normal View” entry to the L3 table. There is room in the Next Hop table, so method (B) is not desirable. If method (A) fails due to hash table contention, method (C) is used to add the new IP host to the LPM table in the reserved-but-unused route space.

Case (4): %L3 is Greater Than %NH, and the LPM Table has no Available Room for IP Hosts.

Try to conserve L3 table space by using method (A) to add the new IP host as a “Normal View” entry to the L3 table. There is room in the Next Hop table, so method (B) is not desirable. There is no free space for IP hosts in the LPM, so method (C) is also not desirable. If method (A) fails due to hash table contention, the following is done to handle extremely limited resources. A new IP host is always added, even if an existing IP host must be removed. Note there might be room for the removed host to be added at a later time, if that removed host is later required for traffic flow (see, for example, prior art U.S. Pat. No. 7,724,734 issued to the assignee of the present application). An existing IP host is removed at random from either the L3 table or LPM table. If removal is from the L3 table, the host is removed from where there is hash contention with the new IP host, thus making space for the new IP host to be added. The LPM table is not organized as a hash table, so any host removed will make space available for the new IP host.

### EMBODIMENTS

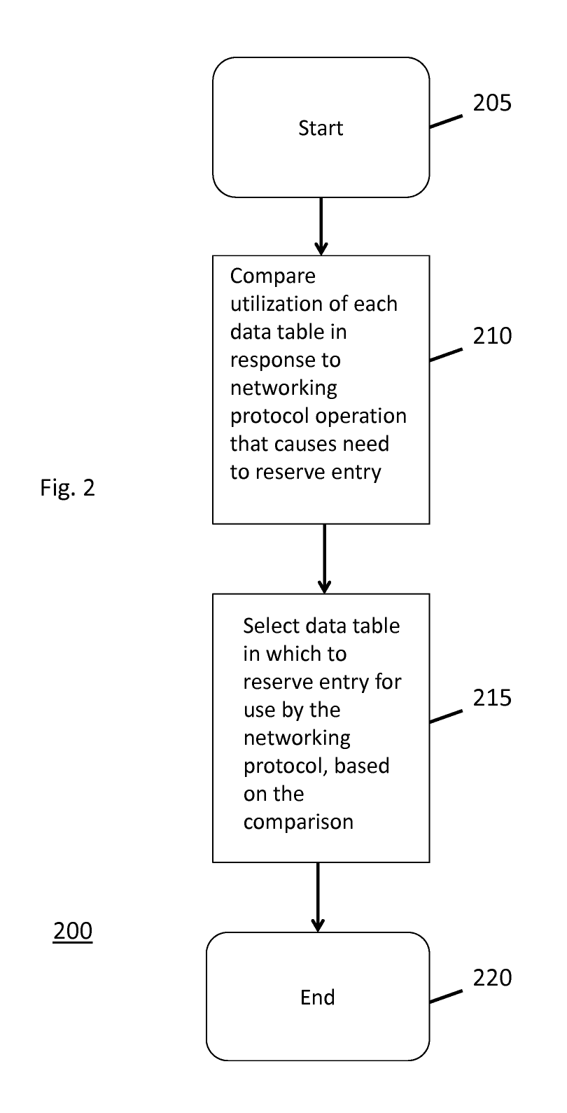

With reference to the flow chart 200 of FIG. 2, in a network switch having a plurality of data tables accessible to a plurality of networking protocols, the plurality of data tables each containing a plurality of entries, one embodiment of the invention provides for a method for selecting one of the plurality of data tables in which to reserve a respective one of the plurality of entries as an entry for use by one of the plurality of networking protocols, the method comprising comparing at 210 a utilization of each of the plurality of data tables responsive to an operation of the one of the plurality of networking protocols that causes a need to reserve the entry, and at 215 selecting the one of the plurality of data tables in which to reserve the entry, responsive to the comparing.

In one embodiment, comparing the utilization of each of the plurality of data tables comprises comparing a current percentage utilization of each of the plurality of data tables, and selecting the one of the plurality of data tables in which to reserve the entry, responsive to the comparing, comprises selecting the one of the plurality of data tables that has a current percentage utilization less than at least one other of the plurality of data tables in which to reserve the entry, responsive to the comparing.

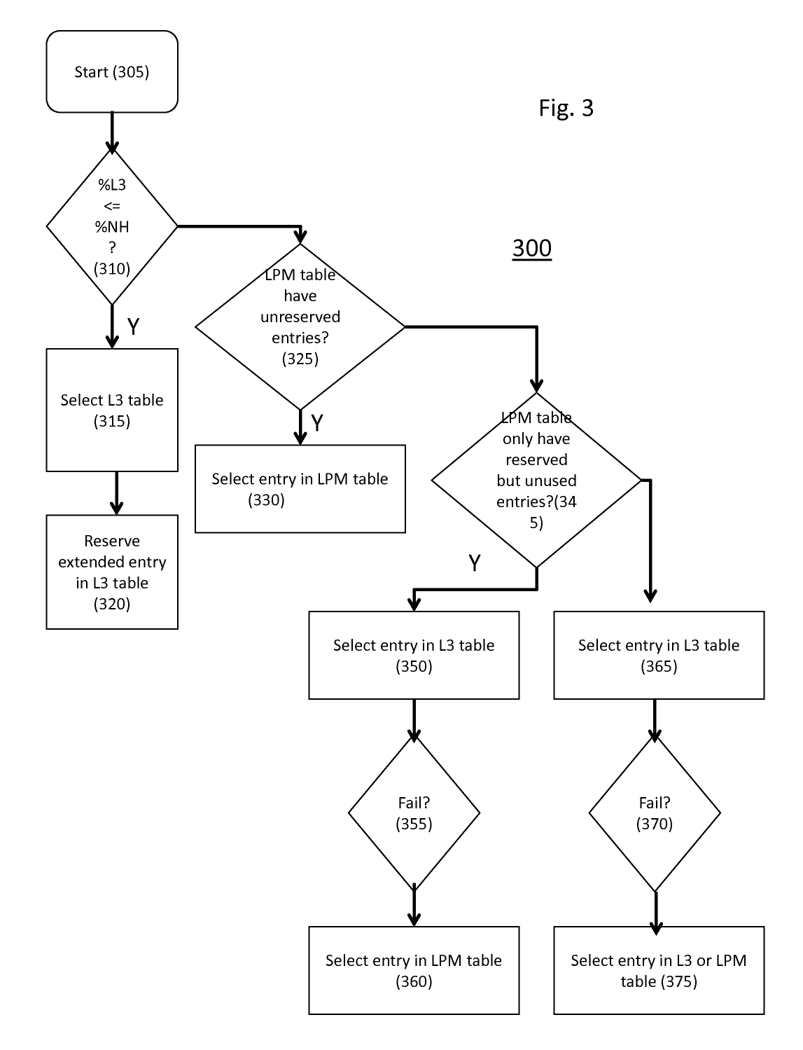

With reference to FIG. 3, according to one embodiment relating to case (1) above, wherein one of the plurality of data tables is a layer-3 lookup table 105, and another one of the plurality of data tables is a next hop table 115, comparing the utilization of each of the plurality of data tables responsive to the operation comprises comparing at 310 a utilization of the layer-3 lookup table (%L3) to a utilization of the next hop table (%NH) responsive to the operation. The embodiment selects at 315 the layer-3 lookup table in which to reserve the entry if the layer-3 lookup table is less utilized than the next hop table.

One embodiment further comprises reserving the entry in the layer-3 lookup table, for example, reserving at 320 an extended entry comprising a first entry in which to maintain an IP destination address, and a second entry associated with the first entry in which to maintain next hop information associated with the IP destination address, in the layer-3 lookup table.

According to one embodiment relating to case (2) described above, wherein the plurality of data tables comprises a layer-3 lookup table, a next hop table, and a longest prefix match table that has unreserved entries available at 140, comparing the utilization of each of the plurality of data tables responsive to the operation comprises comparing at 310 the utilization of the layer-3 lookup table (%L3) to a utilization of the next hop table (%NH) responsive to the operation, and if the utilization of the layer-3 lookup table is greater than the utilization of the next hop table, checking whether the LPM table has unreserved entries available at 325. If the LPM table has unreserved entries available, the process continues at 330 by selecting the longest prefix match table in which to reserve the entry.

One embodiment further comprises reserving the entry in the longest prefix match table, including, for example, selecting the next hop table in which to reserve a next hop entry, and wherein the entry reserved in the longest prefix match table is to contain a pointer to the next hop entry to be reserved in the next hop table.

According to one embodiment relating to case (3) described above, wherein the plurality of data tables comprises the layer-3 lookup table 105, the next hop table 115, and the longest prefix match table 110 that only has reserved but unused entries available at 143, comparing the utilization of each of the plurality of data tables responsive to the operation comprises comparing at 310 a utilization of the layer-3 lookup table to a utilization of the next hop table responsive to the operation. If the utilization of the layer-3 lookup table is greater than the utilization of the next hop table, the process then checks at 325 whether the LPM table has unreserved entries 140 available. If no unreserved entries are available in the LPM table, the embodiment checks at 345 whether there are any reserved but currently unused entries in the LPM table. If so, rather than use those reserved entries, the embodiment further comprises selecting at 350 an entry in the layer-3 lookup table. Another embodiment comprises selecting the next hop table in which to reserve a next hop entry, and wherein the entry reserved in the layer-3 lookup table is to contain a pointer to the next hop entry to be reserved in the next hop table.

According to another embodiment relating to case (3) described above in which the layer-3 lookup table is organized as a hash table, there is hash table contention in the layer-3 lookup table. If the process detects at 355 that the hash to select an entry in the L3 table fails due to contention, then this embodiment alternately selects at 360 the longest prefix match table in which to reserve the entry. One embodiment further comprises reserving the entry in the reserved but unused entries available in the longest prefix match table. Another embodiment further comprises selecting the next hop table in which to reserve a next hop entry, and wherein the entry reserved in the longest prefix match table is to contain a pointer to the next hop entry to be reserved in the next hop table.

According to the embodiment described with respect to Case (4) above, a plurality of data tables comprises a layer-3 lookup table, a next hop table, and a longest prefix match table that has no entries available, whether in unreserved space 140 or reserved space 142. In this embodiment, utilization of the layer-3 lookup table is compared at 310 to utilization of the next hop table responsive to the operation. In one embodiment, the layer-3 lookup table is selected in which to reserve the entry, responsive to the comparing identifying the utilization of the layer-3 lookup table as greater than the utilization of the next hop table.

In this embodiment, the layer-3 lookup table is organized as a hash table, the embodiment further comprising reserving at 365 the entry in the layer-3 lookup table, or selecting at 375 an in-use entry in the layer-3 lookup table if reserving the entry in the layer-3 lookup table fails at 370 due to hash table contention in the layer-3 lookup table and reserving the selected in-use entry in the layer-3 lookup table. Alternatively, the embodiment selects at 375 an in-use entry in the layer-3 lookup table or the longest prefix matching table if reserving the entry in the layer-3 lookup table fails due to hash table contention in the layer-3 lookup table and reserving the selected in-use entry.

In one embodiment, selecting the in-use entry in the layer-3 lookup table or the longest prefix matching table if reserving the entry in the layer-3 lookup table fails due to hash table contention in the layer-3 lookup table comprises selecting the in-use entry at or near a location of hash contention in the layer-3 lookup table at 365. In another embodiment, selecting the in-use entry in the layer-3 lookup table or the longest prefix matching table if reserving the entry in the layer-3 lookup table fails due to hash table contention in the layer-3 lookup table comprises selecting an in-use host entry in the longest prefix match table, for example, selecting a not recently used in-use host entry in the longest prefix match table.

In one embodiment, wherein one of the plurality of data tables is a hash table, comparing the current percentage utilization of each of the plurality of data tables comprises: normalizing the current percentage utilization of the hash table over a range from zero percent of actual current utilization to a threshold percent of actual current utilization that is less than one hundred percent actual current utilization but beyond which threshold percent of actual current utilization the hash table is considered full of entries; and comparing the normalized current percentage utilization of the hash table with the other of the plurality of data tables; and selecting the one of the plurality of data tables in which to reserve the entry, responsive to the comparing, further comprises selecting either the hash table, or one of the other of the plurality of data tables, in which to reserve the entry if the normalized current percentage utilization of the hash table indicates the hash table is substantially full of used entries and the current percentage utilization of the other of the plurality of data tables indicates the other of the plurality of data tables are substantially full of used entries.

Thus, embodiments of the invention automatically adapt to accommodate demands for other types of resources, without the undue burden or disadvantages of manual pre-configuration of other resource types.

1. In a network switch having a plurality of data tables accessible to a plurality of networking protocols, the plurality of data tables each containing a plurality of entries, a method for selecting one of the plurality of data tables in which to reserve a respective one of the plurality of entries as an entry for use by one of the plurality of networking protocols, the method comprising:
comparing a utilization of each of the plurality of data tables responsive to an operation of the one of the plurality of networking protocols that causes a need to reserve the entry; and
selecting the one of the plurality of data tables in which to reserve the entry, responsive to the comparing.

2. The method of claim 1,
wherein comparing the utilization of each of the plurality of data tables comprises comparing a current percentage utilization of each of the plurality of data tables, and
wherein selecting the one of the plurality of data tables in which to reserve the entry, responsive to the comparing, comprises selecting the one of the plurality of data tables that has a current percentage utilization less than at least one other of the plurality of data tables in which to reserve the entry, responsive to the comparing.

3. The method of claim 1, wherein one of the plurality of data tables is a layer-3 lookup table, and another one of the plurality of data tables is a next hop table,
wherein comparing the utilization of each of the plurality of data tables responsive to the operation comprises comparing a utilization of the layer-3 lookup table to a utilization of the next hop table responsive to the operation; and
wherein selecting the one of the plurality of data tables in which to reserve the entry, responsive to the comparing, comprises selecting the layer-3 lookup table in which to reserve the entry if the layer-3 lookup table is less utilized than the next hop table.

4. The method of claim 3, further comprising reserving the entry in the layer-3 lookup table.

5. The method of claim 4, wherein reserving the entry in the layer-3 lookup table comprises reserving an extended entry comprising a first entry in which to maintain an IP destination address, and a second entry associated with the first entry in which to maintain next hop information associated with the IP destination address, in the layer-3 lookup table.

6. The method of claim 1, wherein the plurality of data tables comprises a layer-3 lookup table, a next hop table, and a longest prefix match table that has unreserved entries available,
wherein comparing the utilization of each of the plurality of data tables responsive to the operation comprises comparing a utilization of the layer-3 lookup table to a utilization of the next hop table responsive to the operation; and
wherein selecting the one of the plurality of data tables in which to reserve the entry, responsive to the comparing, comprises selecting the longest prefix match table in which to reserve the entry, responsive to the comparing identifying the utilization of the layer-3 lookup table as greater than the utilization of the next hop table.

7. The method of claim 6, further comprising reserving the entry in the longest prefix match table.

8. The method of claim 7, further comprising selecting the next hop table in which to reserve a next hop entry, and wherein the entry reserved in the longest prefix match table is to contain a pointer to the next hop entry to be reserved in the next hop table.

9. The method of claim 1, wherein the plurality of data tables comprises a layer-3 lookup table, a next hop table, and a longest prefix match table that only has reserved but unused entries available;
wherein comparing the utilization of each of the plurality of data tables responsive to the operation comprises comparing a utilization of the layer-3 lookup table to a utilization of the next hop table responsive to the operation; and
wherein selecting the one of the plurality of data tables in which to reserve the entry, responsive to the comparing, comprises selecting the layer-3 lookup table in which to reserve the entry, responsive to the comparing identifying the utilization of the layer-3 lookup table as greater than the utilization of the next hop table.

10. The method of claim 9, further comprising reserving the entry in the layer-3 lookup table.

11. The method of claim 10, further comprising selecting the next hop table in which to reserve a next hop entry, and wherein the entry reserved in the layer-3 lookup table is to contain a pointer to the next hop entry to be reserved in the next hop table.

12. The method of claim 10, wherein the layer-3 lookup table is organized as a hash table, the method further comprising alternately selecting the longest prefix match table in which to reserve the entry if reserving the entry in the layer-3 lookup table fails due to hash table contention in the layer-3 lookup table.

13. The method of claim 12, further comprising reserving the entry in the reserved but unused entries available in the longest prefix match table.

14. The method of claim 13, further comprising selecting the next hop table in which to reserve a next hop entry, and wherein the entry reserved in the longest prefix match table is to contain a pointer to the next hop entry to be reserved in the next hop table.

15. The method of claim 1, wherein the plurality of data tables comprises a layer-3 lookup table, a next hop table, and a longest prefix match table that has no entries available;
wherein comparing the utilization of each of the plurality of data tables responsive to the operation comprises comparing a utilization of the layer-3 lookup table to a utilization of the next hop table responsive to the operation; and wherein selecting the one of the plurality of data tables in which to reserve the entry, responsive to the comparing, comprises selecting the layer-3 lookup table in which to reserve the entry, responsive to the comparing identifying the utilization of the layer-3 lookup table as greater than the utilization of the next hop table.

16. The method of claim 15, wherein the layer-3 lookup table is organized as a hash table, the method further comprising:
reserving the entry in the layer-3 lookup table;
selecting an in-use entry in the layer-3 lookup table if reserving the entry in the layer-3 lookup table fails due to hash table contention in the layer-3 lookup table and reserving the selected in-use entry in the layer-3 lookup table.

17. The method of claim 15, wherein the layer-3 lookup table is organized as a hash table, the method further comprising:
reserving the entry in the layer-3 lookup table;
selecting an in-use entry in the layer-3 lookup table or the longest prefix matching table if reserving the entry in the layer-3 lookup table fails due to hash table contention in the layer-3 lookup table and reserving the selected in-use entry.

18. The method of claim 17, wherein selecting the in-use entry in the layer-3 lookup table or the longest prefix matching table if reserving the entry in the layer-3 lookup table fails due to hash table contention in the layer-3 lookup table comprises selecting the in-use entry at or near a location of hash contention in the layer-3 lookup table.

19. The method of claim 17, wherein selecting the in-use entry in the layer-3 lookup table or the longest prefix matching table if reserving the entry in the layer-3 lookup table fails due to hash table contention in the layer-3 lookup table comprises selecting an in-use host entry in the longest prefix match table.

20. The method of claim 19, wherein selecting an in-use host entry in the longest prefix match table comprises selecting a not recently used in-use host entry in the longest prefix match table.

21. The method of claim 2, wherein one of the plurality of data tables is a hash table, wherein comparing the current percentage utilization of each of the plurality of data tables comprises:
normalizing the current percentage utilization of the hash table over a range from zero percent of actual current utilization to a threshold percent of actual current utilization that is less than one hundred percent actual current utilization but beyond which threshold percent of actual current utilization the hash table is considered full of entries; and
comparing the normalized current percentage utilization of the hash table with the current percentage utilization of the other of the plurality of data tables; and
wherein selecting the one of the plurality of data tables in which to reserve the entry, responsive to the comparing, further comprises selecting either the hash table, or one of the other of the plurality of data tables, in which to reserve the entry if the normalized current percentage utilization of the hash table indicates the hash table is substantially full of used entries and the current percentage utilization of the other of the plurality of data tables indicates the other of the plurality of data tables are substantially full of used entries.
